(19) United States
(12) Patent Application Publication
(10) Pub. No.: US 2017/0255719 A1
(43) Pub. Date: Sep. 7, 2017

(54) DYNAMIC MOTION SOLVER METHODS AND SYSTEMS

(71) Applicant: XARKIN SOFTWARE, PERTH (CA)

(72) Inventor: MICHAEL KELLY, PERTH (CA)

(21) Appl. No.: 15/445,352

(22) Filed: Feb. 28, 2017

Related U.S. Application Data
(60) Provisional application No. 62/303,499, filed on Mar. 4, 2016.

(51) Int. Cl. G06F 17/50

(52) U.S. Cl. CPC G06F 17/5009

(57) ABSTRACT

The simulation of motion for articulated assemblies is important within a range of industries from computer gaming, virtual reality through to android/robot developments and exoskeletons/prosthesis for individuals. However, even low complexity systems with only a small number of moving parts are computationally intractable with respect to analytic solutions. Accordingly, simulations are employed which are themselves complex. It would be beneficial therefore to provide a means of creating actuation and motion sequences for an articulated assembly from a description of the properties of the assembly, the properties of the desired motion, the properties of the terrain over which the assembly will move, and a set of physical laws governing the motion. By framing desired motion within the input parameters allows creation of actuation and motion sequences conforming to the target based upon these four input elements within tolerances which are defined for one or more of input elements or combinations of them.

### CROSS-REFERENCE TO RELATED APPLICATIONS

This patent application claims the benefit of priority from U.S. Provisional Patent Application 62/303,499 filed Mar. 4, 2016 entitled “Dynamic Motion Solver”, the entire contents of which are herein incorporated by reference.

### FIELD OF THE INVENTION

This invention relates to the design and simulation of articulated assemblies, such as robots, prosthesis, and animated characters, and more specifically to the modeling of articulated assemblies with rigid and/or flexible arbitrary shaped segments and their resulting motion sequences.

### BACKGROUND OF THE INVENTION

Articulated assemblies are comprised of a number of rigid and/or flexible segments of arbitrary shape and the joints between them. Segments may additionally have mechanisms attached to them which will affect the way the segment will interact with an obstruction, a support surface, or other segments of the articulated assembly. For example, a segment may have a wheel or track mechanism at one end to provide control of the endpoint when it is in contact with a support surface instead of relying on the static physical properties of the segment and the support surface such as static and dynamic coefficients of friction. Assemblies may be formed from or may contain tree-shaped structures of connected segments. Assemblies may be formed from or may contain loops of connected segments. Assemblies may include specifications for passive driving elements such as springs and dampers, for example. Assemblies may include specifications for active driving elements such as motors, for example. Assemblies may or may not be anchored to an immovable reference point. An example of an unanchored assembly is a free-standing legged robot whilst an example of an anchored assembly is a manufacturing robot arm fastened to a static workstation. Representations of articulated assemblies, desired motions for them, the terrain over which they will move, and the physical laws which motion should obey are the four elements central to the design and simulation of actual motion sequences of those assemblies, and the actuations of the active driving elements of those assemblies to produce the desired motions.

In a design system, topological representations of articulated assemblies are constructed by specifying the individual bodies, or segments, in the assembly and the joints between those segments. The properties and behaviors of the segments and joints in the assembly may be specified as part of the design process, or separately in a different design system at the same or other time. Properties of segments may include, for example, geometry and mass, and may include any such properties of the assembly that might affect its actuations or the resulting motions. Properties of joints include the number and nature of the degrees of freedom for each joint, and may include, for example, limits on motion, a spring constant, and maximum force or torque values for active drivers associated with a degree of freedom. The design stage may be a precursor to constructing or modifying a physical assembly.

In the same or different design system, terrain properties are specified. The specification may contain, for example, i) spatial information, such as the altitude and slope of the terrain at each point, and the presence of steps, ii) material information, such as the static and dynamic coefficients of friction and the spring constant representing the elasticity at each point on the terrain, iii) fluid cover information, such as the depth of fluid, its density, its viscosity, and its velocity at each point on the terrain, and iv) obstruction information, including immobile objects such as building and trees, or mobile objects such as vehicles or other assemblies, which may or may not completely prevent an assembly from occupying the same space as the obstruction.

In the same or different design system, motions for an articulated assembly are specified. The specification may contain, for example, i) spatial information, such as the path to follow for the motion, ii) behavioral information, such as the speed at which motion should occur, iii) timing information such as time instants at, or intervals during which, an event should occur, or time intervals over which a given motion or portion of the motion should occur, and iv) information about periodic or aperiodic motion elements to be superimposed on a base motion. The motion specification may include elements at different levels of detail. An example of a high-level specification is that a legged assembly's overall motion should be to walk, run or hop. An example of a low-level specification is an exact path in space and time to be followed by the assembly, one of its segments, or indeed one point on one of its segments. The motion specification may also include actuations of driving elements, for example the application of a given torque at a given joint for a particular time interval.

The motion specification may take different forms. It may contain elements that are textual or options chosen from a menu, it may contain elements which are graphically entered, for example using an electronic version of an assembly as a marionette, or it may contain elements resulting from a motion capture either of the assembly which is the subject of the solver or of some other assembly, possibly a living being. In the case of motion capture information, it may be or have been modified before being supplied as input to the current invention.

In the same or different design system, the physical laws of motion to be obeyed by the assembly may be specified. They may or may not be the physical laws governing the real world. For example, gravity or spring forces may vary as defined by a square law, as in the real world, or they may vary according to powers other than 2. As another example, forces or torques may influence objects linearly, via equations such as F=ma or τ=Iα, or according to a power other than 1.

The specifications of these four elements, i) an assembly, ii) a terrain specification, iii) a motion specification, and iv) a set of physical laws, may be imprecise, incomplete or inconsistent within themselves or across the four elements.

Accordingly, there remains a need for a system which can determine actuations of an assembly's active driving elements and motions of the assembly which satisfy a motion specification, subject to a set of physical laws, for an assembly moving over a specified terrain, within tolerances of modification and completion for each of those elements such that the solution is complete and consistent. One or more of those elements may be modified or completed in whole or in part in producing the actuation sequence and resulting motion. For example, a visual animation system may maintain low tolerance for modification of assembly, terrain, and motion elements while having a higher tolerance for modification of physical laws. In such a case, an animation may show the assembly, terrain, and motion elements to be very close to those given, but the animated character may float or accelerate unnaturally, corresponding to a high tolerance for modification of physical laws. Another example is the computation of an actuation sequence for a visual animation system or a physical robot, which may have higher tolerance for modification of the motion element while maintaining low tolerance for modification of assembly, terrain, and physical law elements. In such a case, the motion and actuation sequence may embody the assembly and terrain very closely to those given, but adhere to the motion specification only in so far as can be done while adhering closely to the given physical laws. Yet another example is an assembly design system, which may have high tolerance for modification of the assembly element while maintaining low tolerance for modification of the terrain, motion, and physical law elements.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to design and simulation of articulated assemblies, such as robots, prosthesis, and animated characters, and more specifically to the modeling of articulated assemblies with rigid and/or flexible arbitrary shaped segments and their resulting motion sequences.

In accordance with an embodiment of the invention there is provided a method comprising:

(a) defining and initializing a solution property space within a memory of a computer system;
(b) establishing an assembly specification relating to an articulated assembly and populating a first subset of the solution property space in dependence upon the assembly specification information;
(c) establishing a terrain specification relating to a terrain over which the articulated assembly is to move and populating a second subset of the solution property space in dependence upon the terrain specification;
(d) establishing a motion specification defining the motion of the articulated assembly over the terrain and populating a third subset of the solution property space in dependence upon the motion specification information;
(e) defining parameterised curves relating to modifiable properties within the solution property space to generate values for said modifiable properties;
(f) simulating the dynamic motion of the articulated assembly over the terrain in dependence upon the solution property space to establish a solved property space;
(g) generating an error value relating to the level of inconsistency between the determined values in the solved property space and the values of the solution property space;
(h) determining whether the error value meets a predetermined threshold; wherein upon determining the error value meets the predetermined threshold establishing the solved property space as the result; and
upon determining the error value does not meet the predetermined threshold varying a subset of the modifiable properties in dependence upon the parameterised curves and repeating steps (e) to (h) with the solution property space adjusted for the varied subset of the modifiable properties.

In accordance with an embodiment of the invention there is provided a system comprising: an articulated assembly providing motion of the articulated assembly over terrain;

a microprocessor coupled to a non-volatile, non-transitory memory for establishing a control sequence for controlling the articulated assembly; and the non-volatile, non-transitory memory for storing data relating to the articulated assembly and computer executable instructions which when executed relate to a process establishing the control sequence, the process comprising the steps of:
(a) defining and initializing a solution property space within a memory of a computer system;
(b) establishing an assembly specification relating to an articulated assembly and populating a first subset of the solution property space in dependence upon the assembly specification information;
(c) establishing a terrain specification relating to a terrain over which the articulated assembly is to move and populating a second subset of the solution property space in dependence upon the terrain specification;
(d) establishing a motion specification defining the motion of the articulated assembly over the terrain and populating a third subset of the solution property space in dependence upon the motion specification information;
(e) defining parameterised curves relating to modifiable properties within the solution property space to generate values for said modifiable properties;
(f) simulating the dynamic motion of the articulated assembly over the terrain in dependence upon the solution property space to establish a solved property space;
(g) generating an error value relating to the level of inconsistency between the determined values in the solved property space and the values of the solution property space;
(h) determining whether the error value meets a predetermined threshold; wherein upon determining the error value meets the predetermined threshold using the established solved property space to control the articulated assembly; and
upon determining the error value does not meet the predetermined threshold varying a subset of the modifiable properties in dependence upon the parameterised curves and repeating steps (e) to (h) with the solution property space adjusted for the varied subset of the modifiable properties.

In accordance with an embodiment of the invention there is provided a non-volatile, non-transitory memory for storing computer executable instructions which when executed relate to a process comprising the steps of:

(a) defining and initializing a solution property space within a memory of a computer system;
(b) establishing an assembly specification relating to an articulated assembly and populating a first subset of the solution property space in dependence upon the assembly specification information;
(c) establishing a terrain specification relating to a terrain over which the articulated assembly is to move and populating a second subset of the solution property space in dependence upon the terrain specification;
(d) establishing a motion specification defining the motion of the articulated assembly over the terrain and populating a third subset of the solution property space in dependence upon the motion specification information;
(e) defining parameterised curves relating to modifiable properties within the solution property space to generate values for said modifiable properties;
(f) simulating the dynamic motion of the articulated assembly over the terrain in dependence upon the solution property space to establish a solved property space;
(g) generating an error value relating to the level of inconsistency between the determined values in the solved property space and the values of the solution property space;
(h) determining whether the error value meets a predetermined threshold; wherein
upon determining the error value meets the predetermined threshold establishing the solved property space as the result; and
upon determining the error value does not meet the predetermined threshold varying a subset of the modifiable properties in dependence upon the parameterised curves and repeating steps (e) to (h) with the solution property space adjusted for the varied subset of the modifiable properties.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary flowchart for a dynamic motion solver according to an embodiment of the invention;

FIG. 2 depicts an exemplary algorithm for establishing the solution to a dynamic system using random perturbations according to an embodiment of the invention;

FIG. 3 depicts an exemplary pseudocode representation for the solution to a dynamic system using gradient search according to an embodiment of the invention;

FIG. 4 depicts a network environment within which embodiments of the invention may be employed; and

FIG. 5 depicts a wireless portable electronic device supporting communications to a network such as depicted in FIG. 4 and as supporting embodiments of the invention.

### DETAILED DESCRIPTION

The present invention is directed to the design and simulation of articulated assemblies, such as robots, prosthesis, and animated characters, and more specifically to the modeling of articulated assemblies with rigid and/or flexible arbitrary shaped segments and their resulting motion sequences.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) or “mobile electronic device” (commonly referred to as a mobile) as used herein and throughout this disclosure, refers to a wireless device used for communications and other applications that requires a battery or other independent form of energy for power. A PED may be recharged from a fixed interface to obtain power and also be connected to a wired communications interface. This includes devices, but is not limited to, such as a cellular telephone, smartphone, personal digital assistant (PDA), portable computer, pager, portable multimedia player, portable gaming console, a navigation system, laptop computer, tablet computer, a wearable device, an implanted device, a smart card, portable PoS, mobile PoS (mPoS), a motorized vehicle, a non-motorized vehicle, public transit vehicle, a vehicle guided by tracks and/or rails, an aircraft, a lighter-than-air device, a drone, a robot, an android, a biomedical device, an item of medical equipment and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a terminal, a gaming console, a digital set-top box, a base station, a wireless network access node/point, a network device, an automated teller machine (ATM), an automated banking machine (ABM), an analog set-top box, an Internet enabled appliance, an Internet enabled television, a PoS, a vending machine, a self-service device or system, a robotic system, an item of medical equipment, an entertainment system and a multimedia player.

A “computer server” (commonly known as a server) as used herein, and throughout this disclosure, refers to one or more physical computers co-located and/or geographically distributed running one or more services as a host to users of other computers, servers, PEDs, FEDs, etc. to serve the client needs of these other users. This includes, but is not limited to, a database server, file server, mail server, print server, web server, gaming server, virtual environment server, utility provider server, service provider server, goods provider server, financial server, financial registry server, personal server, and a Government regulatory server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED, FED and/or server.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook™, Google+™ Tumblr™ and Twitter™; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowd-sourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility provider, a financial provider and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of service providers, members of a financial registry, members of utility providers, members of retailers, members of organizations, members of charities, men, women and children. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user profile information, and personal information. It may also include a user's biometric information, an estimation of the user's biometric information, or a projection/prediction of a user's biometric information derived from current and/or historical biometric information, and current—historical profile information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List of file formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities.

“Geo-location” as used herein refers to, but is not limited, to the identification or estimation of the real-world geographic location of an object. In its simplest form geo-location involves the generation of a set of geographic coordinates and is closely related to the use of positioning systems, such as global positioning systems (GPS). However, other non-satellite based systems may be employed including for example geo-locating or positioning based upon a location engine exploiting wireless/radio frequency (RF) location methods such as Time Difference of Arrival (TDOA) where such information is accessible from multiple wireless transponders to allow triangulation. Alternatively, wireless base stations/cell towers can be employed to triangulate the approximate position through timing/power information of the multiple wireless base stations/cell towers which whilst subject to many sources of error beneficially supports indoor environments as well as outdoor environments where GPS satellite signals are weak or blocked. Other geo-location methods can include Internet and computer geo-location by associating a geographic location with the Internet Protocol (IP) address, MAC address, RFID, Wi-Fi access node etc. IP address location data can include information such as country, region, city, postal/zip code, latitude, longitude and time zone. Geo-location data may be defined in international standards such as ISO/IEC 19762-5:2008 or as defined by other standards or proprietary formats.

An “assembly” as used herein and through this disclosure refers to, but is not limited to, a combination of manufactured parts into a complete machine, structure or unit of a machine wherein the assembly comprises one or more segments which are coupled together via joints which have N degrees of freedom (0≦N≦6). The assembly may comprise actuators as segments (e.g. linearly extending segment), joints (e.g. motorised rotary joint), or actuators joining segments (e.g. a screw drive connecting two segments or a spring between two segments). An assembly may comprise elements such as wheels, tracks, etc. attached to segments at specific points including ends of segments etc. Examples of assemblies may include, but are not limited to, a bipedal android, a prosthetic hip replacement, an exoskeleton for a construction work, a robot with eight legs, a tracked vehicle, and a quadruped. Assemblies may be, but are not limited to, fully finished products in their own right, full simulations for direct viewing, a skeleton or exoskeleton of a product visualized with or without the body of the product, a mechanical representation of a human figure, a mechanical representation of an animal, and a mechanical representation of an imagined creature or vehicle.

“Terrain” (or relief or topographical relief) as used herein and through this disclosure refers to, but is not limited to, the vertical and/or horizontal dimensions of a surface upon which an articulated assembly moves through a fluid. Terrain accordingly, is used as a general term with respect to the physical geography, referring to the lay of the land, and is usually expressed in terms of the elevation, slope, and orientation of terrain features. Terrain may therefore refer to, but is not limited to, an area of land with air as the fluid, an area of the bottom of an ocean or other aqueous structure with water as the fluid, and an area of a surface from a solid or frozen material with a gaseous or liquid fluid.

A “segment” as used herein and through this disclosure refers to, but is not limited to, one of the parts (segments) into which something naturally separates or is divided. A segment may therefore be, but is not limited to, a division, a portion, or a section.

A “joint” as used herein and through this disclosure refers to, but is not limited to, a point at which parts of an artificial structure are joined. A joint may have N degrees of freedom (0≦N≦6) being within one frame of reference, X, Y, and Z linear axes together with roll, pitch, and yaw rotary axes around the X, Y and Z axes respectively. A joint may provide multiple axes within a single element or by combining several elements together. The X, Y, Z, roll, pitch and yaw axes for a joint may be renamed based upon their position and orientation within the articulated assembly.

A “physical law” (scientific law) as used herein and through this disclosure refers to, but is not limited to, a theoretical statement “inferred from particular facts, applicable to a defined group or class of phenomena, and expressible by the statement that a particular phenomenon always occurs if certain conditions be present.” Physical laws are typically conclusions based on repeated scientific experiments and observations over many years and which have become accepted universally within the scientific community. Such physical laws may include, but are not limited to, conservation of energy, conservation of momentum, conservation of angular momentum, conservation of mass, hydrodynamic continuity equation, gravity, and laws of motion (e.g. Newton, Euler).

“Motion” as used herein and through this disclosure refers to, but is not limited to, a change in position of an object over time. Motion may be described in terms of displacement, distance, velocity, acceleration, time and speed. Motion of a body is typically observed by attaching a frame of reference to an observer and measuring the change in position of the body relative to that frame.

The present invention provides a method for determining a consistent and complete set of specifications for i) an assembly, ii) a terrain, iii) a motion of the assembly, and iv) a set of physical laws, given specifications for these four elements which may be imprecise, incomplete or inconsistent within themselves or across all or a subset of the four elements. The given specifications may include tolerances for the modification of zero or more properties associated with the elements of that specification. As a minimum, the given specifications will include a specification of an assembly which will contain at least the number of segments, a set of joints connecting particular or relative points on pairs of segments, and the degrees of freedom associated with each joint. Unspecified terrain, motion and physical law values may be set to default values, specified in the embodiment of the invention being employed. For example, the terrain may default to a flat surface with high coefficients of friction, motion may default to a walk in a straight line at a constant speed for a fixed amount of time, and the physical laws may default to the normal values for the surface of the Earth.

The specifications for each of the four elements, if given, in whatever level of detail they are given, and whether in whole or in part, are stored as data sets in the memory of a computer system and may be derived from one or more databases associated with the computer system or one or more other computer systems connected to the computer system via one or more networks such as the Internet, for example.

The input information may include a time period between solution property values in the output. If unspecified, the time period will be set to a default value, as specified within the embodiment of the invention. Exemplary output time periods may be set to 1/24 of a second, the standard for animation, where the embodiment of the invention relates to computer simulation for gaming, multimedia content etc., or to 1 millisecond ( 1/1000 second) within other embodiments of the invention relating to simulation of physical systems. The simulation system's internal time period employed for computation, referred to in the following description, may or may not be the same as the output time period.

The input specifications may indicate which of the specification property values can be modified in order to produce an output solution, and the tolerances on those modifications. If unspecified, which property values can be modified and the extend that they can be varied are set to default values, specified in the embodiment of the invention. For example, i) the gravity constant may default to an unmodifiable value of g=−9.81 m/s², and ii) the path to be followed by the assembly center of mass may default to a straight line of 10 meters in length, with a tolerance of ±0.1 meters of vertical or lateral deviation.

The input information may include an allowable error threshold for the solution. If unspecified, the error threshold will be set to a default value, specified in the embodiment of the invention.

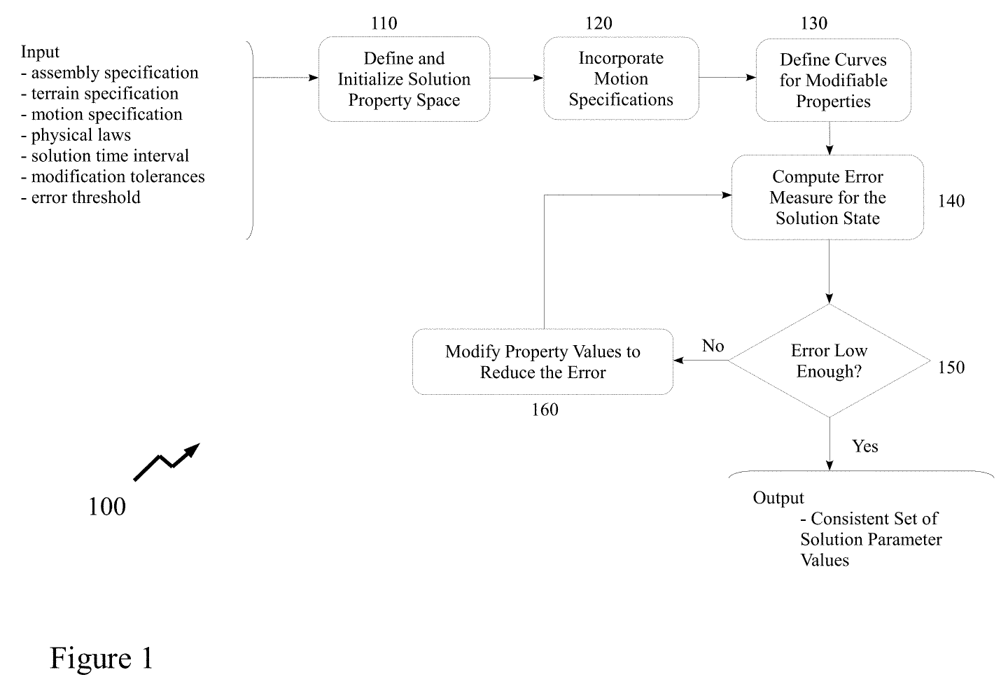

An exemplary flowchart 100 for a dynamic motion solver according to an embodiment of the invention is depicted in FIG. 1. As depicted a set of input parameters are established and entered into the flowchart 100 which comprises a sequence of steps comprising:
Step 110 wherein the solution property space is defined and initialized;
Step 120 wherein the motion specifications are incorporated;
Step 130 wherein a family of curves are defined for modifiable properties;
Step 140 wherein the error for the solution state is determined;
Step 150 wherein a determination is made as to whether the error is sufficiently low wherein the process either terminates or loops back through step 160;
Step 160 wherein the property values are adjusted to seek reduction in the error.

Within the following sections there are presented more detailed descriptions of the blocks within flowchart 100 in FIG. 1.

A: Define and Initialize Solution Property Space

Corresponding to step 110 in FIG. 1 the solution space for the dynamic motion solver according to an embodiment of the invention acquires a set of solution properties, which may be represented as values stored in one or more computer memories, which when given complete and consistent values represent a solution to the dynamic motion problem. Accordingly, such a set of solution properties may comprise an input set and an output set. As depicted in FIG. 1 an input set may be comprised of multiple subsets of data relating to elements of the motion system including, but not limited to, an assembly specification (e.g. segment properties (A1) and joint properties (A2), a terrain specification (e.g. A3), a motion specification, physical law definitions (A4), solution time specification, modification tolerance values, and an error threshold whilst the output set may comprise the consistent set of solution parameter values meeting the desired error threshold or lowest error achieved.

Accordingly, a set of solution properties may be defined as follows wherein from the numbers and configurations of segments and joints within a given assembly, a subset of solution properties relating to the assembly, which will be assigned specific values, is derived. This subset may comprise, but not be limited to, segment properties (A1) and joint properties (A2).

A1: Segment Properties:

These may comprise, but not be limited to, the following properties for each segment within the configuration of segments:
i) its mass,
ii) its length,
iii) a moment tensor associated with the segment's principle axes,
iv) a reference frame, which may coincide with its principle axes, may be chosen to coincide with axes defined by a joint attachment point, or may be chosen arbitrarily,
v) the position of the segment in a chosen reference frame, which may be, for example, a reference frame common to the assembly and the terrain, or relative to one or more other segments,
vi) the orientation of the segment in a chosen reference frame, which may be, for example, a reference frame common to the assembly and the terrain, or relative to one or more other segments,
vii) the force at each point the segment has in contact with the terrain,
viii) the linear velocity of the segment in a chosen reference frame, which may be, for example, a reference frame common to the assembly and the terrain, or relative to one or more other segments,
ix) the angular velocity of the segment in a chosen reference frame, which may be, for example, a reference frame common to the assembly and the terrain, or relative to one or more other segments; and
x) connections of the segment to other segments either directly (e.g. fixed) or indirectly (e.g. through a joint) together with the joint(s) and any fixed/flexible elements (e.g. wheels, tracks, equipment etc) connected to the segment.

A2: Joint Properties:

These may comprise, but not be limited to, the following properties for each joint within the configuration of segments and joints (the assembly):
i) a specification of each degree of freedom,
ii) positional state with respect to each of its degrees of freedom,
iii) the force and torque applied equally and oppositely on the two segment point to which the joint is attached to maintain the integrity of the joint, and
iv) the force or torque applied by each active driver for each of the joint's degrees of freedom;
v) connections of the joint to other joints either directly (e.g. linked joints) or indirectly (e.g. through a segment) together with the segment(s) and any fixed/flexible elements (e.g. wheels, tracks, equipment etc) connected to the joint.

A3: Terrain Properties:

These may comprise, but not be limited to, the properties for the surface or surfaces that the assembly is to dynamically move through (e.g. cross) and/or an environmental parameter which modifies the properties of the surface or surfaces. For example, a terrain segment of grass has different coefficients of friction if the grass is dry, wet, or wet and below freezing point (i.e. the grass is frosted with ice particles). This subset may comprise, but not be limited to:
i) its altitude;
ii) physical dimensions;
iii) cross-section function (e.g. linear sloping, random with specified surface height variations)
iv) its static coefficient of friction;
v) its dynamic coefficient of friction; and
vi) environmental scaling factors for static and dynamic coefficients of friction.

A4: Physical Laws:

These may comprise, but not be limited to, the physical laws for the global environment within which the assembly is to dynamically move through. This subset may comprise, but not be limited to:
i) the magnitude of the gravitational constant;
ii) spatial variation of gravitational constant within the defined frame of reference for the assembly;
iii) conservation of energy, momentum and angular momentum;
iv) laws of motion, e.g. Newtonian, Lagrangian, Hamiltonian;
v) mechanical formulation, e.g. Euler's laws of motion and Euler's rigid body dynamics; and
vi) environmental formulation, e.g. hydrodynamic equations for fluid assembly moving through.

It would be evident that adjustments within the physical laws allow the dynamic motion of an assembly to be evaluated under different real world scenarios, e.g. an assembly moving from a ground based surface in air to a ground based surface underwater, an assembly moving within different gravitational environments (e.g. Earth and Mars), or the adjustments in the assemblies motion as it speeds up within an environment (e.g. air, water, etc.). It would be further evident that the adjustments within the physical laws allow for the dynamic motion of an assembly to be established in real world environments as well as those established based upon projections of physical environments (e.g. projected conditions on surface of another planet within the solar system or a completely artificial environment defined by the imagination of an author, director, user.)

Accordingly, the full set of solution properties may be comprised of one or more of these subsets of solution properties (A1 through A4) as well as others defined previously or defined in respect of the application, assembly, etc. For all subsets of solution properties, space for storing them is allocated within one or more computer memories. Alternatively, solution properties may be centrally stored for the dynamic modeling but are established in dependence upon data stored within other remote servers, for example, such that the user may define for example a steel assembly to move across a specific geographic location wherein the mechanical properties of the steel segments are retrieved from multiple manufacturer databases as are the properties of the specified joints whilst the terrain properties are established from a third-party mapping service.

Within an embodiment of the invention the DYnamic MOtion Solver System (DYMOSS) may store one value for a given solution property, which is valid for all time. Within other embodiments of the invention the DYMOSS may store solution property values for each computational time instant, not necessarily aligned with the time period specified for solution property output. It would also be evident that not all solution properties need be treated the same way such that the DYMOSS may store a single value for all time for some solution properties whereas other solution properties may be varying for each instant of time.

With respect to temporal modeling then embodiments of the invention may specify multiple configurations, including, but not limited to:
a fixed interval of time between stored solution property values;
a predetermined variable interval of time between stored solution property values;
a variable interval of time between stored solution property values wherein the time intervals are established in dependence upon one or more solution properties, for example storing values at finer granularity when dynamic motion solution values are changing relatively more rapidly or motion is over a highly variable terrain versus a smooth terrain;
a variable interval of time between stored solution property values wherein the time intervals are established in dependence upon one or more solution properties. A third embodiment may modify the interval of time between stored solution property values during the computation of a solution, for example adjusting granularity based upon speed of the assembly.

Within embodiments of the invention the solution of the DYMOSS at each time instant are stored as discrete values or alternatively the DYMOSS may establish locally within the time periods mathematical functions of the solution properties as a function of time such that the resulting DYMOSS result can be run at different time periods without re-running the DYMOSS. For example, the DYMOSS may locally fit a mathematical function for a time point, P(0), based upon it and the previously stored values P(−2*dt), P(−dt), P(+dt), and P(+2*dt), where dt equals the time interval within the DYMOSS model solution, so that the mathematical functions are determined once the P(+2*dt) values have been established. Accordingly, localized mathematical functions may be employed or alternatively once the DYMOSS has executed the solution a single mathematical function is established having best fit to all points. Other options would be evident to one of skill in the art.

Within embodiments of the invention the solution of the DYMOSS at each time instant are stored as discrete values or alternatively the DYMOSS may encode those values in the form of a time-based function using which discrete values can be calculated as required. For example, a positional coordinate, x, which has values which change linearly with time, t, could have those values encoded as a linear equation of the form x=mt+b, where “m” and “b” are values chosen such that the “x” values computed by inserting values for “t” correspond to the desired discrete values of “x” for those time instants. Other options would be evident to one of skill in the art.

For terrain and physical law solution properties, as well as storing values for them for times as described above, values may be stored for those times for different locations. For example configurations may include, but are not limited to:
define a single value for some of the solution properties for all locations;
define a grid of fixed granularity over the range of the terrain and store values for some of the solution properties for each polygon defined by the grid;
define an irregular grid and store values for some of the solution properties for each polygon defined by the grid.

Further, not all terrain and physical law solution properties need be treated in the same manner. Accordingly, within an embodiment of the invention a single value for some solution properties may be stored for all polygons defining a terrain grid (map) whilst other solution properties may have different values for each polygon defined within the terrain grid (map). For example, a floor may be more or less slippery at different locations in a property which is partly hardwood and partly tiled, gravity may be different at different locations on a massive body, and virtual gravity may be different at different locations in a rotating space station.

Within an embodiment of the invention the initial state of the solution parameter space may be determined as outlined below. Note that this is not the initial state of a time sequence, but an initial state for all of the solution values across all time instants for a generated sequence of processes.

Process P1:

Portions of an initial state are established by assigning values to the following solution properties for each time instant, and for terrain and physical law properties for each location based upon the input solution properties. If any of these input solution properties are not defined then provided in the specification then these may be set to default values of which the following are exemplary steps within the process of the DYMOSS configuration setting, Process 1.
P1-A: all unspecified segment masses are set to default values using a default mass value for any segment or a default density meaning that the mass will be computed using given or default segment dimensions, specific to the embodiment of the invention being employed which may include, but are not limited to:
P1-B: all unspecified segment lengths are set to default values, specified in the embodiment of the invention being employed;
P1-C: all unspecified segment shapes are set to default values, specified in the embodiment of the invention being employed, for example cylindrical of a specific radius and of uniform density, thereby allowing the calculation of their moment tensors;
P1-D: all unspecified segment reference frames are set to default values, specified in the embodiment of the invention being employed, for example the segment's principle axes;
P1-E: all unspecified forces and torques are assigned default values, specified in the embodiment of the invention being employed, for example zero;
P1-F: all unspecified linear and angular velocities are assigned default values, specified in the embodiment of the invention being employed, for example zero;
P1-G all unspecified joint degrees of freedom are assigned defaults, specified in the embodiment of the invention being employed, for example point joints allowing unrestricted rotation in any direction, having spring constants and damping factors of zero, and no active drivers;
P1-H: all unspecified terrain altitudes are assigned default values, specified in the embodiment of the invention being employed, for example zero;
P1-I: all unspecified terrain static and dynamic coefficients of friction are assigned default values, specified in the embodiment of the invention being employed, for example one; and
P1-J: all unspecified physical laws are assigned default values, specified in the embodiment of the invention being employed, for example acceleration due to gravity may be set to −9.81 m/s².

Process P2:

The remaining elements of the initial state are established by assigning values to the solution properties for the segment positions, segment orientations, joint positions for each degree of freedom for each time instant etc. If any of these input solution properties are not defined then provided in the specification then these may be set to default values of which the following are exemplary steps within the process of the DYMOSS configuration setting, Process 2 which may include, but are not limited to:
P2-A: all specific positional values are specified, these values are stored in the initial state;
P2-B: all partial positional values are specified, these values are stored in the initial state, and any further values that can be derived from the given ones and the constraints of the assembly topology using known methods of inverse kinematics are stored in the initial state; and
P2-C: all values which are not specified and cannot be derived from specified ones using inverse kinematics are filled in by repeating the following until all values are assigned: one vacant value in the initial state is assigned a default value, specified in the embodiment of the invention being employed, and any further values that can be derived from the non-vacant ones and the constraints of the assembly topology using inverse kinematics are stored in the initial state.

Any properties included in the solution property space and not explicitly named above are assigned default values, specified in the embodiment of the invention being employed. The intention is to have defined initial values for all solution space properties in preparation for computing final solution property values. Some of those will be as set as described above, and some of those will be replaced as described in the next section.

B: Incorporate Motion Specifications

Corresponding to step 120 in FIG. 1 then once all solution parameter initial values are assigned as described above, any additional motion specifications relating to segment positions and orientations or to joint degree of freedom positions not of the specific type used to set initial solution property values as described above are processed to re-assign solution property values associated with segment positions and orientations, and with joint degree of freedom positions. This may be performed through the user of prototype motion templates, for example, in either formulaic or explicit form which are either part of or available to the embodiment of the invention, and may be optionally undertaken in a straight-forward manner by only considering positional information and constraints. In this process, re-assignment means overwriting values in the computer memory corresponding to the solution property space.

According to an embodiment of the invention the DYMOSS may accept a motion specification indicating that the assembly walk from a start position to an end position on the terrain in a specified amount of time. An embodiment accepting such a specification may contain a library of assembly structures, as examples a humanoid biped, a three-legged alien, or a quadruped in the proportions of a horse, and prototype cyclic walking motions for those assembly structures. Assigning solution parameter values is done by shaping the given assembly as specified by the prototype walk for the structure most closely matching it and moving that structure over the terrain such that the assembly remains in contact with the surface of the terrain at all times, which is one of the properties of walking, and the center of mass of the assembly moves from the start position to the end position on the terrain in the specified amount of time.

According to another embodiment of the invention the DYMOSS may accept a motion specification which defines a cyclic walking motion for the given assembly, a start position and an end position on the terrain, and a time interval. A cyclic walking motion is, for example, a specification of the orientation of one particular segment in the assembly with respect to a common frame of reference for the assembly and the terrain, and the positions of each of the joint degrees of freedom at a sequence of time instants, where the set of positions at the first time instant and at the last time instant are at least approximately equal so that the sequence can be smoothly repeated. Using the specifications of those segment and joint positions, the position of the center of mass over the terrain at each time instant as specified by the start position, end position, and time interval, solution parameter values for segment and joint positions and orientations can be assigned in the memory space allotted them.

According to another embodiment of the invention the DYMOSS may accept a motion specification which indicates that a particular point on a segment trace a particular path or relative path in a given time interval. Examples of this would be a path to be followed by an end-effector for a manufacturing robot. Using inverse kinematics, the positions and orientations of segments and joints can be computed using the position specified for the point on the segment and the position of the attachment point of the arm to a reference point in the assembly by a joint.

Where a motion specification is incomplete or ambiguous, one or more values required to complete it or resolve any ambiguities are set to default values, specified in the embodiment of the invention being employed.

Where a prototype or template is supplied by an embodiment of the invention corresponding to a motion specification, that prototype or template specification is typically subsumed into the motion specification, and is subject to modification for the purposes of solving the dynamic system.

Where motions specifications conflict with each other, or with other elements of the specification, one will be given priority over the other. Accordingly other embodiments of the invention may provide the DYMOSS with a conflict resolution strategy which may be internally defined. According to another embodiment of the invention the DYMOSS may accept priority assignments as part of the element specifications.

Within embodiments of the invention the user may be able to select a motion template from a plurality of motion templates associated with the DYMOSS. For example, the DYMOSS in determining that the articulated assembly is bipedal may offer walk, run, step, climb, crawl, etc. as motion templates that have been established by one or more parties such as the supplier of the DYMOSS, a third party service provider, a software developer, etc. These may have been established through their own design—simulation processing for their own articulated assembly, as a commercial activity, or established through image processing a motion capture sequence of a physical assembly. Such templates may be obtained from third parties etc. by downloading from remote servers and installed as accessible templates. Such templates may be scaled, segmented, repeated sequentially, etc. individually or combined in sequence using techniques known within the art. For example, a user may take a “walk” template which repeats a predetermined number of times and then a “run” template that similarly repeats for a predetermined number of times. The number of repeat cycles may be determined by the DYMOSS as human walking for example has a typical speed range whilst an android may have a wider walking speed range and hence the user can adjust or define. In other embodiments the template is scaled according to the overall solution space or aspects of it such as terrain specification or motion specification.

After conflict resolution is complete and all or some subset of motion specifications or portions thereof have been applied, linear and angular velocity values are re-computed for each segment. According to an embodiment of the invention the DYMOSS would calculate each velocity at each time instant by subtracting the velocity at the previous instant from two times the position delta between the previous and the current time instants divided by the time difference between them.

C: Define Curves for Modifiable Values

Corresponding to step 130 in FIG. 1 then the DYMOSS defines for each solution property which allows different values at different times and which is not specified to have, or by default given the behavior to have, a zero tolerance to modification, a curve which conforms to the initial value sequence for that solution property, that is, the curve may be used to generate the solution property values to within some degree of precision. The curve definition may allow for ignoring exceptional or outlying points, for example, to cause a smoothing of motion or actuation in the solution output, or to reduce the influence of error values in input data, such as motion capture data. An embodiment of the invention will store the definitions of these curves in the memory of a computer.

Curve definitions may take different forms, for example, cubic splines, b-splines, or polynomial curves, etc. The number of control parameters for a curve may differ from the number of solution property values. According to an embodiment of the invention the DYMOSS may use a number of control parameters equal to one quarter the number of solution property values. According to another embodiment of the invention the DYMOSS may use a set of control parameters equally spaced in time. According to another embodiment of the invention the DYMOSS may use a set of control parameters sufficient to define a curve which matches the corresponding solution property values to within some error amount.

It would be evident that in some instances, for example where templates or prototypes are used to generate solution property values, that these curves may already be defined. The curves used by an embodiment of the invention in the solution computation may or may not be the same curves or the same types of curves used to generate the solution property values, and may or may not be defined by the same number of control parameters.

D: Compute the Error Measure for the Solution State

Relating to step 140 in FIG. 1 the DYMOSS according to embodiments of the invention will define an error measure for the solution space, or accept one as part of the problem specification. The error measure is a numeric value representing how close the set of solution properties is to being completely self-consistent. According to an embodiment of the invention the DYMOSS may define the error measure using the following algorithm to calculate it:
D1: initialize the total error value to zero;
D2: for each segment in the assembly;
D3: for each time instant;
D4-A: compute the sum of all forces and torques on the segment at the given time instant;
D4-B: apply the sum of all forces and torques on the segment for a duration equal to the difference between the current time instant and the next one to calculate a projected position for the segment;
D5: compute the partial error for the segment for the given time instant to be the difference between the calculated new position and the one stored in the solution properties for the next time instant, where that partial error may be the sum of the squares of the distances for a defined set of points on the segment between their projected positions and the positions stored in the solution properties for the next time instant; and
D6: add the partial error for the segment for the given time instant to the total error value.

According to another embodiment of the invention the DYMOSS may compute the error value as above but, may additionally include squared differences of velocity values, those velocity values being the ones stored in the solution properties and the ones computed for the projected position of the segment.

According to another embodiment of the invention the DYMOSS may allow for the inclusion of human judgment of the given solution state, alone or in addition to a calculated value, to give that state an error value.

According to another embodiment of the invention the DYMOSS error measure may include aggregate values to be optimized, examples are i) total energy consumed, ii) peak torque applied, and iii) total path length. An embodiment of the invention could include in the error measure calculation factors representing these absolute values, or these values relative to a target value.

E: Error Low Enough

Corresponding to step 150 within FIG. 1 the error established within step 140 is assessed as to whether the error is low enough or not. If the error is low enough the process proceeds to generate the output set of consistent solution parameter values. If not, the process proceeds to step 160.

Optionally, the error determination may be a weighted summation of multiple errors or may be based solely upon a subset of parameter values reaching an acceptable error or may require all errors be within the required acceptable error. Accordingly, achieving a path between start and end points within a specified time may be more important than the path taken or the path taken is more important and time taken is lower importance or both may be important.

It would be evident that other factors may be included which have not been described or depicted within respect to the Figures in that, for example, a power consumption may be estimated based upon the time, speed, trajectory, assembly motion etc. and that achieving the target objective without draining all power is highest importance over path and time as in that scenario a robot or android would be stranded away from the next power source or completing the task.

F: Modify Values to Reduce the Error

Based upon the execution of the DYMOSS the solution for the modeled dynamic system is a set of solution parameter values for which the error measure is (ideally) below some acceptance threshold or represents the lowest.

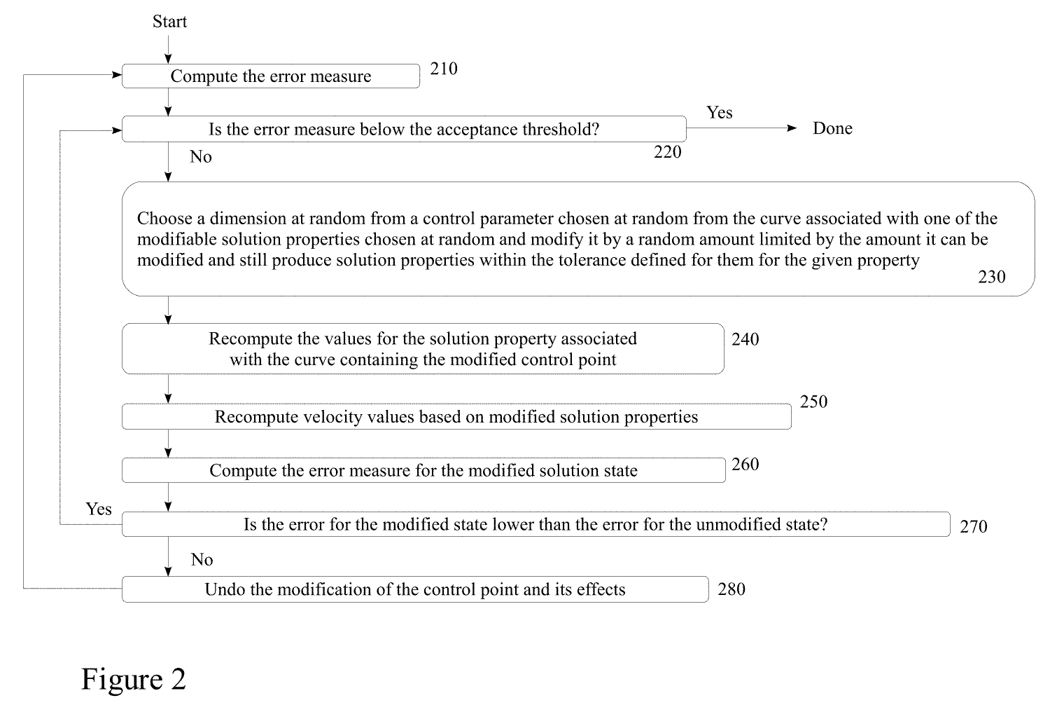

According to another embodiment of the invention the DYMOSS may exploit a general method of random perturbation of values for finding that solution such as depicted in FIG. 2. As depicted the process flowchart comprises steps 210 to 280 which comprise:
Step 210 wherein the error measure is computed;
Step 220 where the determination is made whether the error is below the acceptance threshold where if yes the process terminates otherwise it proceeds to step 230;
Step 230 wherein a dimension is chosen at random from a control parameter chosen at random from the curve associated with one of the modifiable solution properties chosen at random and modify it by a random amount limited by the amount it can be modified and still produce solution properties within the tolerance defined for them for the given property;
Step 240 wherein the values for the solution property associated with the curve containing the modified control point are recomputed;
Step 250 wherein velocity values based on modified solution properties are recomputed;
Step 260 wherein the error measure for the modified solution state is calculated;
Step 270 wherein the error measure of the modified state is compared to the error state of the unmodified state such that a positive determination leads to the process flow cycling back to step 220 otherwise it proceeds to step 280; and
Step 280 wherein the modification of the control point are undone and the process proceeds back to step 210.

According to another embodiment of the invention the DYMOSS could compute the loop in FIG. 2 in parallel with one or more other processes. Accordingly, copies of the set of solution properties and of the curve definitions could be made from the master set, one for each modifiable control parameter of the curves representing the modifiable solution properties. Accordingly, in parallel, each control parameter could be modified, associated solution properties would be recomputed, and the error measure for the modified state would be computed. If the error measure for the modified state is lower than the error for the unmodified state, the modified value for the control parameter would be copied back to the master set. After all parallel computations are complete and modifications to the master set made, solution properties in the master set would be recomputed and loop would be completed by recomputing the error measure. According to another embodiment of the invention the DYMOSS may cause more than one value to be tested for each control parameter in a single loop, either by using more than one parallel thread for the computation of a given parameter, or by having each thread make multiple attempts.

Considering modifications of curve control parameters, an embodiment of the invention may use a more efficient mechanism for modifying parameter values than random choice. According to another embodiment of the invention the DYMOSS may exploit a method which computes three error measures with a given parameter value set to i) its existing value, ii) a value higher than its existing value, and iii) a value lower than its existing value, and using, for example, a quadratic curve to find the parameter value that minimizes the error measure. According to another embodiment of the invention the DYMOSS may exploit quadratic approximation as one method of performing a gradient search.

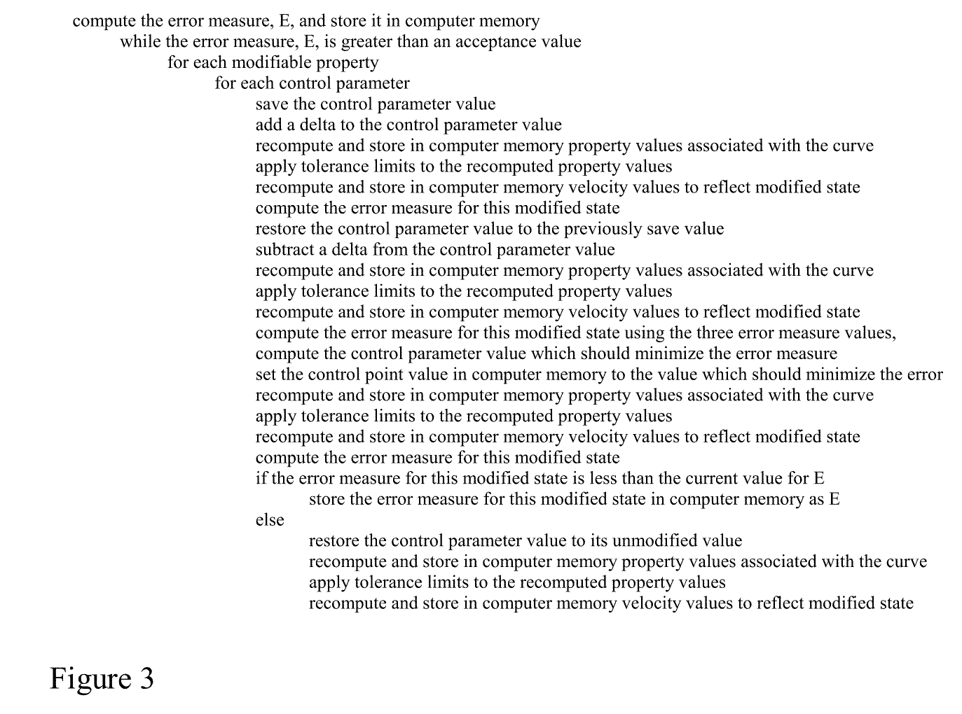

An embodiment of the invention using this more efficient method for modifying parameter values to reduce the error measure would employ a computer to execute the method depicted in FIG. 3 wherein pseudocode for applying tolerance limits on modifications of curve parameter values as an alternative or in addition to applying tolerance limits on recomputed property values.

According to another embodiment of the invention the DYMOSS may define a derived or aggregated set of properties to represent the problem at a coarser granularity, creating a problem definition of lower computational cost to solve. The solution at coarse granularity would then be used to further constrain the original problem space, reducing the cost of solving it.

According to another embodiment of the invention the DYMOSS may define the position of the assembly's center of mass as a single property, and define a curve with control parameters for that center of mass property, and store those values in computer memory. A coarse grain problem would then be defined using i) the center of mass property and its curve, ii) any motion properties that relate directly to the assembly's center of mass, for example the path to be followed by the center of mass and related timing information, but not positional properties associated with individual segments or joints, iii) the positions and timings for assembly contacts with terrain or obstacles, derived from assembly, terrain, and obstacle properties in the original problem definition, and iv) any physical laws that affect the position of the center of mass, for example, gravity.

Within a coarse grain problem definition according to an embodiment of the invention, the forces associated with contact points may be used, for example, to reach or maintain the altitude of the center of mass of the assembly over the terrain within the tolerances specified for that measure, and other solution properties may be modified to compensate for the lateral components of those contact forces, which exist whenever a contact point is not directly below, with respect to gravity, the assembly's center of mass. That compensation may, for example, take the form of modifications of the lateral position of the assembly's center of mass, or modifications of the positions or timings of the contact points.

According to an embodiment of the invention the DYMOSS may then use the position of the center of mass and the computed contact points and forces as constraints on the tolerances for the modifications of other property values in the original problem, in particular, but not limited to, the positional property values for individual assembly segments and joints.

According to an embodiment of the invention the DYMOSS may solve the coarse grain problem as for the original problem. According to another embodiment of the invention the DYMOSS may use the method defined in FIG. 3 to solve first the coarse grain problem, then similarly solve the original problem with additional constraints supplied by the solution to the coarse grain problem.

According to another embodiment of the invention the DYMOSS may define the coarse grain problem by additionally defining orientation properties for the assembly and use those properties in the calculation of the error measure for the independent curves. That is, contact forces with the terrain could be used to achieve or maintain the orientation of part of the assembly or the assembly as a whole, along with the altitude of the assembly over the terrain. For example, it may be desirable that the assembly rotate end over end as it moves forward, or that it remain upright but alternately turn through some angle to the right and to the left as it moves forward.

According to an embodiment of the invention the resulting solution (solved property space or solved (resulting) solution state) may be employed to control the articulated assembly to provide the modeled motion across the terrain.

According to an embodiment of the invention the DYMOSS may be continually in execution solving multiple potential solution spaces in real time based upon, for example, a user's activity and/or location etc. for a prosthesis or exoskeleton currently associated with them or by an autonomous robot/android performing tasks. Accordingly, the DYMOSS may solve for options available to the user such as walking along a path within a retail environment/factory etc. and determining solutions for three options, the first being progressing forward along the path, the second walking and turning left on another path about 2 meters (6 feet) from the current user location, and the third stopping. Optionally, some solutions such as stopping the walking motion of a bipedal articulated assembly may be initially computed and subsequently stored for retrieval and execution, as may walking, stepping up, stepping down, and starting to walk etc. These stored solutions may then be executed to account for the current terrain or environment and could be expected to iterate to a solution faster than those starting further away in terms of initial solution. Optionally the solution stored may be employed directly with the terrain, environment, physical laws etc. are within predetermined tolerances of those used in the initial establishment of the solution.

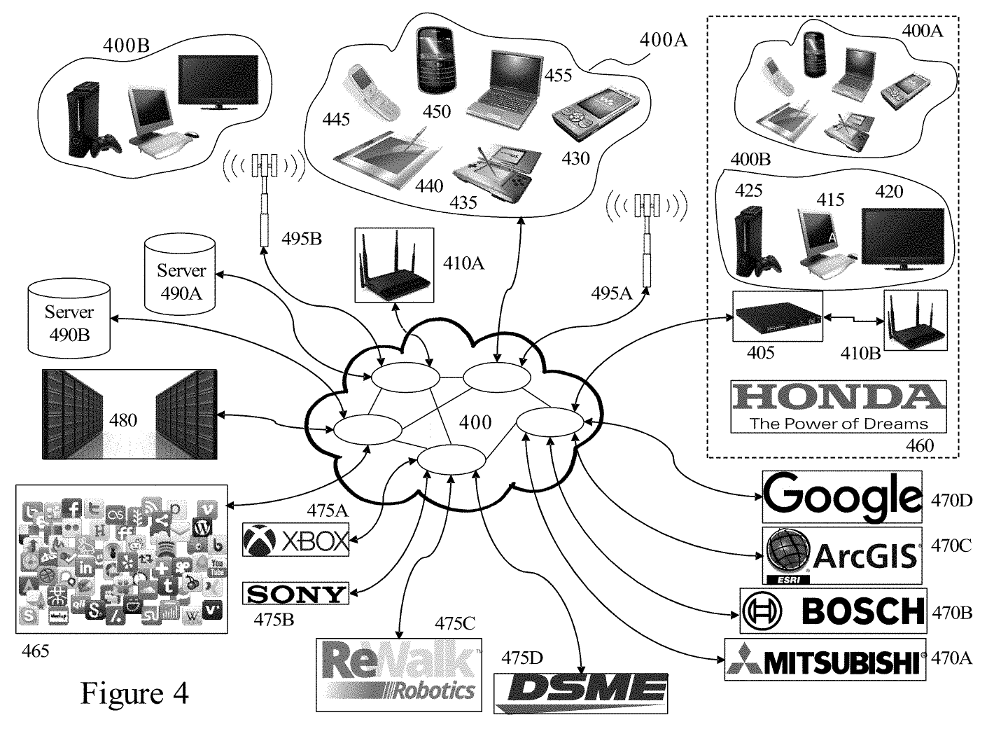

Referring to FIG. 4 there is depicted a network environment 400 within which embodiments of the invention may be employed supporting Dynamic Motion Solver Systems and Dynamic Motion Solver Applications/Platforms (DMS-DMSAPs) according to embodiments of the invention. Such DMS-DMSAPs, for example, supporting multiple communication channels, dynamic filtering, etc. As shown first and second user groups 400A and 400B respectively interface to a telecommunications network environment 400. Within the representative telecommunication architecture, a remote central exchange 480 communicates with the remainder of a telecommunication service providers network via the network environment 400 which may include for example long-haul OC-48/OC-192 backbone elements, an OC-48 wide area network (WAN), a Passive Optical Network, and a Wireless Link. The central exchange 480 is connected via the network environment 400 to local, regional, and international exchanges (not shown for clarity) and therein through network environment 400 to first and second cellular APs 495A and 495B respectively which provide Wi-Fi cells for first and second user groups 400A and 400B respectively. Also connected to the network environment 400 are first and second Wi-Fi nodes 410A and 410B, the latter of which being coupled to network environment 400 via router 405. Second Wi-Fi node 410B is associated with commercial service provider 460, e.g. Honda™ comprising other first and second user groups 400A and 400B. Second user group 400B may also be connected to the network environment 400 via wired interfaces including, but not limited to, DSL, Dial-Up, DOCSIS, Ethernet, G.hn, ISDN, MoCA, PON, and Power line communication (PLC) which may or may not be routed through a router such as router 405.

Within the cell associated with first AP 410A the first group of users 400A may employ a variety of PEDs including for example, laptop computer 455, portable gaming console 435, tablet computer 440, smartphone 450, cellular telephone 445 as well as portable multimedia player 430. Within the cell associated with second AP 410B are the second group of users 400B which may employ a variety of FEDs including for example gaming console 425, personal computer 415 and wireless/Internet enabled television 420 as well as cable modem 405. First and second cellular APs 495A and 495B respectively provide, for example, cellular GSM (Global System for Mobile Communications) telephony services as well as 3G and 4G evolved services with enhanced data transport support. Second cellular AP 495B provides coverage in the exemplary embodiment to first and second user groups 400A and 400B. Alternatively the first and second user groups 400A and 400B may be geographically disparate and access the network environment 400 through multiple APs, not shown for clarity, distributed geographically by the network operator or operators. First cellular AP 495A as show provides coverage to first user group 400A and environment 470, which comprises second user group 400B as well as first user group 400A. Accordingly, the first and second user groups 400A and 400B may according to their particular communications interfaces communicate to the network environment 400 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 400A may form associations either through standards such as IEEE 802.15 and Bluetooth as well in an ad-hoc manner.

Also connected to the network environment 400 are Social Networks (SOCNETS) 465, first and second original equipment manufacturers (OEMs) 470A and 470B respectively, e.g. Mitsubishi™ and Bosch™, first and second third party service providers 470C and 470D respectively, e.g. ArcGIS™ and Google™. Also connected to the network environment 400 are first and second entertainment system providers 475A and 475B respectively, e.g. Microsoft Xbox™ and Sony™ together with first and second robotic exoskeleton manufacturers, e.g. ReWalk Robotics™ and DSME™ (division of Daewoo), together with others, not shown for clarity. Accordingly, a user such as commercial service provider 460 engages with multiple users, e.g. other commercial and/or individuals to provide dynamic motion systems to them. Accordingly, these devices, systems, etc. exploiting DMS-DMSAPs may access resources including those within their own organization, e.g. commercial service provider 460 (Honda™), together with first and second OEMs 470A and 470B respectively, e.g. Mitsubishi™ and Bosch™, or other service providers such as first and second service providers 470C and 470D respectively, ArcGIS™ and Google™. For example, first and second entertainment system providers 475A and 475B respectively, e.g. Microsoft Xbox™ and Sony™, may exploit DMS-DMSAPs either to generate motion of characters, equipment, robotic systems etc. within the gaming environment or control/manage/design a device/system associated with a gaming environment for example. Alternatively, first and second robotic exoskeleton manufacturers, e.g. ReWalk Robotics™ and DSME™, may exploit DMS-DMSAPs according to embodiments of the invention to design/manage/control exoskeleton systems.

For example, a user with a robotic exoskeleton hip replacement may have the hip replacement exploiting a DMS-DMSAP according to an embodiment of the invention to dynamically control the robotic exoskeleton according to the environment which may be derived based upon factors such as geo-location, real-time image processing of acquired images of user's field of view, radar/lidar, infrared laser scanning, stereoscopic image processing etc. Optionally, in addition to such information the DMS-DMSAP may access content from one or more SOCNETs such that, for example, content identifying a particular locations stairs as slippery or uneven is captured and merged to the input parameters of the DMS-DMSAP.

Also depicted are first and second servers 490A and 490B may host according to embodiments of the inventions multiple services associated with a provider of dynamic motion solution systems and dynamic motion solution applications/platforms (DMS-DMSAPs); a provider of a SOCNET or Social Media (SOME) exploiting a DMS-DMSAP; a provider of a SOCNET and/or SOME not exploiting a DMS-DMSAP; a provider of services to PEDS and/or FEDS exploiting a DMS-DMSAP features or a DMS-DMSAP; a provider of one or more aspects of wired and/or wireless communications; an Enterprise 460 such as robotics manufacturer, computer gaming developer, educational institution, exoskeleton manufacturer, prosthesis manufacturer, etc.; license databases; content databases; image databases; content libraries; customer databases; websites; material databases; component databases for segments and/or joints; and software applications for download to or access by FEDs and/or PEDs exploiting and/or hosting DMS-DMSAP features. First and second primary content servers 490A and 490B may also host for example other Internet services such as a search engine, financial services, third party applications and other Internet based services.

Accordingly, a user may exploit a PED and/or FED within an Enterprise 460, for example, and access one of the first or second primary content servers 490A and 490B respectively to perform an operation such as accessing/downloading an application which provides DMS-DMSAP features according to embodiments of the invention; execute an application already installed providing DMS-DMSAP features; execute a web based application providing DMS-DMSAP features; or access content. Similarly, a user may undertake such actions or others exploiting embodiments of the invention exploiting a PED or FED within first and second user groups 400A and 400B respectively via one of first and second cellular APs 495A and 495B respectively and first Wi-Fi nodes 410A.

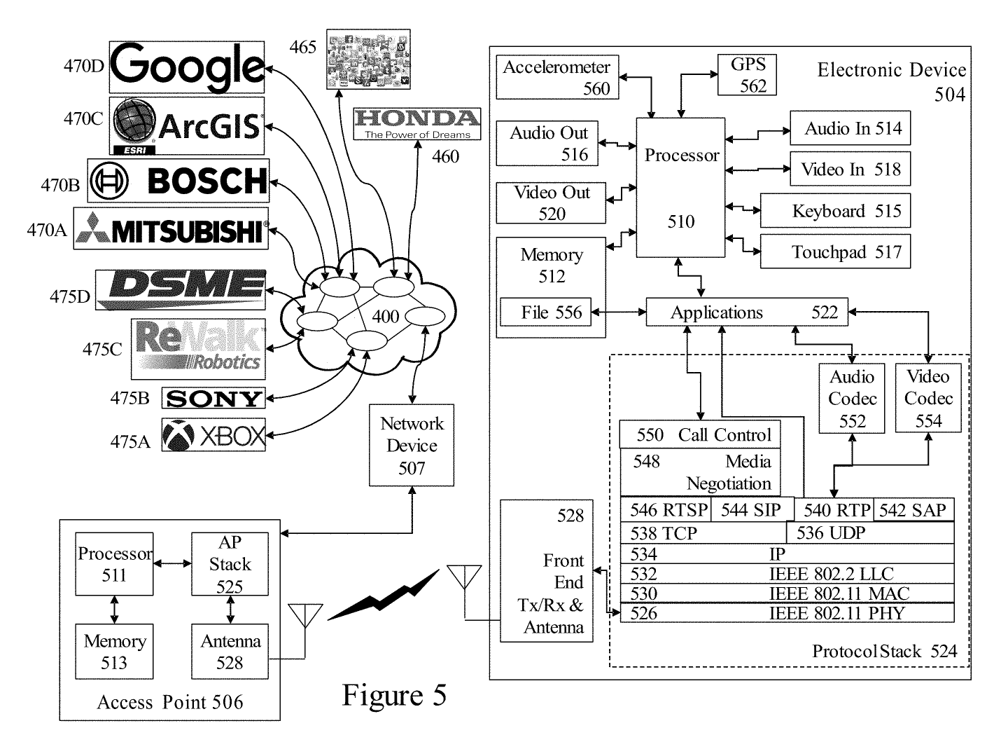

Now referring to FIG. 5 there is depicted an electronic device 504 and network access point 507 supporting DMS-DMSAP features according to embodiments of the invention. Electronic device 504 may, for example, be a PED and/or FED and may include additional elements above and beyond those described and depicted. Also depicted within the electronic device 504 is the protocol architecture as part of a simplified functional diagram of a system 500 that includes an electronic device 504, such as a smartphone 455, an access point (AP) 506, such as first AP 410, and one or more network devices 507, such as communication servers, streaming media servers, and routers for example such as first and second servers 490A and 490B respectively. Network devices 507 may be coupled to AP 506 via any combination of networks, wired, wireless and/or optical communication links such as discussed above in respect of FIG. 4 as well as directly as indicated. Network devices 507 are coupled to network environment 400 and therein Social Networks (SOCNETS) 465, first and second original equipment manufacturers (OEMs) 470A and 470B respectively, e.g. Mitsubishi™ and Bosch™, first and second third party service providers 470C and 470D respectively, e.g. ArcGIS™ and Google™. Also connected to the network environment 400 are first and second entertainment system providers 475A and 475B respectively, e.g. Microsoft Xbox™ and Sony™ together with first and second robotic exoskeleton manufacturers, e.g. ReWalk Robotics™ and DSME™ (division of Daewoo), together with others, not shown for clarity.

The electronic device 504 includes one or more processors 510 and a memory 512 coupled to processor(s) 510. AP 506 also includes one or more processors 511 and a memory 513 coupled to processor(s) 510. A non-exhaustive list of examples for any of processors 510 and 511 includes a central processing unit (CPU), a digital signal processor (DSP), a reduced instruction set computer (RISC), a complex instruction set computer (CISC) and the like. Furthermore, any of processors 510 and 511 may be part of application specific integrated circuits (ASICs) or may be a part of application specific standard products (ASSPs). A non-exhaustive list of examples for memories 512 and 513 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 504 may include an audio input element 514, for example a microphone, and an audio output element 516, for example, a speaker, coupled to any of processors 510. Electronic device 504 may include a video input element 518, for example, a video camera or camera, and a video output element 520, for example an LCD display, coupled to any of processors 510. Electronic device 504 also includes a keyboard 515 and touchpad 517 which may for example be a physical keyboard and touchpad allowing the user to enter content or select functions within one of more applications 522. Alternatively, the keyboard 515 and touchpad 517 may be predetermined regions of a touch sensitive element forming part of the display within the electronic device 504. The one or more applications 522 that are typically stored in memory 512 and are executable by any combination of processors 510. Electronic device 504 also includes accelerometer 560 providing three-dimensional motion input to the process 510 and GPS 562 which provides geographical location information to processor 510.

Electronic device 504 includes a protocol stack 524 and AP 506 includes a communication stack 525. Within system 500 protocol stack 524 is shown as IEEE 802.11 protocol stack but alternatively may exploit other protocol stacks such as an Internet Engineering Task Force (IETF) multimedia protocol stack for example. Likewise, AP stack 525 exploits a protocol stack but is not expanded for clarity. Elements of protocol stack 524 and AP stack 525 may be implemented in any combination of software, firmware and/or hardware. Protocol stack 524 includes an IEEE 802.11-compatible PHY module 526 that is coupled to one or more Front-End Tx/Rx & Antenna 528, an IEEE 802.11-compatible MAC module 530 coupled to an IEEE 802.2-compatible LLC module 532. Protocol stack 524 includes a network layer IP module 534, a transport layer User Datagram Protocol (UDP) module 536 and a transport layer Transmission Control Protocol (TCP) module 538.

Protocol stack 524 also includes a session layer Real Time Transport Protocol (RTP) module 540, a Session Announcement Protocol (SAP) module 542, a Session Initiation Protocol (SIP) module 544 and a Real Time Streaming Protocol (RTSP) module 546. Protocol stack 524 includes a presentation layer media negotiation module 548, a call control module 550, one or more audio codecs 552 and one or more video codecs 554. Applications 522 may be able to create maintain and/or terminate communication sessions with any of devices 507 by way of AP 506. Typically, applications 522 may activate any of the SAP, SIP, RTSP, media negotiation and call control modules for that purpose. Typically, information may propagate from the SAP, SIP, RTSP, media negotiation and call control modules to PHY module 526 through TCP module 538, IP module 534, LLC module 532 and MAC module 530.

It would be apparent to one skilled in the art that elements of the electronic device 504 may also be implemented within the AP 506 including but not limited to one or more elements of the protocol stack 524, including for example an IEEE 802.11-compatible PHY module, an IEEE 802.11-compatible MAC module, and an IEEE 802.2-compatible LLC module 532. The AP 506 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 504 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 5 depicts an Electronic Device 504, e.g. a PED, wherein one or more parties including, but not limited to, a user, users, an enterprise, enterprises, third party provider(s), wares provider(s), service provider(s), original equipment manufacturer, designer, design studio, component supplier, etc. may engage in one or more activities with a DMS-DMSAP according to embodiments of the invention.

For example, a user's prosthesis, such as a leg for example, may be designed and specified using a DMS-DMSAP according to an embodiment of the invention. Such a prosthesis would be typically powered, what the inventor refers to as an active exoskeleton, rather than an unpowered (passive exoskeleton) prosthesis such as a hip replacement. Accordingly, the prosthesis rather than operating in fixed predetermined modes such as within the prior art, e.g. walk, climb stairs, may operate in an adaptive mode wherein the current context/environment of the user and the desired result for the user are inputs to the DYMOSS/DMS-DMSAP according to an embodiment of the invention and accordingly the active exoskeleton responds to the context/environment/desired result in real time. In this manner the DYMOSS/DMS-DMSAP may establish a terrain specification of the solution property space based upon the user's current location and a mode specification of the solution property space based upon either the user's current mode, e.g. walk, or a selection made by the user, e.g. step up or walk and step-up.

Additionally, the DMS-DMAP may monitor sensors associated with the modeled and implemented system so that the DMS-DMAP obtains feedback directly or this may also be fed back to remote databases for assessment versus the desired (target) motion in order to identify common restrictions/limitations that the dynamic motion system presents to users. Accordingly, remote servers may identify limitations, unforeseen circumstances, segment/joint aging characteristics etc. Such factors may be introduced into lifetime assessments of dynamic motion systems whether exoskeletons, androids, remote devices, etc. as well as providing unique characteristics to simulated environments such that the behaviour of an “old” android may be different from a “new” android of the same design.

Accordingly, it would be evident to one of skill in the art that critically the methodology and solutions presented supra in respect of FIGS. 1 to 5 and embodiments of the invention that the DYMOSS computation is framed with a proposed output as part of the initial solution state rather than taking some inputs and computing forward to get an output. Accordingly, the “error” established which the DYMOSS within DMS-DMSAPs seeks to minimize or reduce to below a predetermined threshold quantifies the inconsistency amongst the elements in the solution state. With all inputs and outputs in the same “pool” they can all be treated equally and in particular they can be varied (within bounds), e.g. as determined by a gradient analysis or equivalent to reduce the error measure.

For example, consider a robotic joint with both an actuator (equivalent to a muscle) and a spring wherein it's elements are moving at given initial velocities (which are not variables) and an actuator force is to be calculated to get the joint into a desired state in a given amount of time. Initializing the solution state means filling in the initial positions and velocities, a proposed force by the actuator, the desired final position, the desired final velocities, and the force of the spring, which depends on the initial and final positions of the joint. Once solved for the final positions and final velocities from the initial positions, initial velocities and the actuator and spring forces, the result may not be the desired final values. These difference define the error and accordingly from that result the desired final position, the desired final velocities or the actuator force, can be varied although if the desired final position is changed then the spring force changes. Accordingly, by making changes based on the error gradient, the solution state will approach an acceptable solution. It will be evident that systems with even a small number of moving parts are computationally intractable with respect to analytic solutions.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. A1-though a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
(a) defining and initializing a solution property space within a memory of a computer system;
(b) establishing an assembly specification relating to an articulated assembly and populating a first subset of the solution property space in dependence upon the assembly specification information;
(c) establishing a terrain specification relating to a terrain over which the articulated assembly is to move and populating a second subset of the solution property space in dependence upon the terrain specification;
(d) establishing a motion specification defining the motion of the articulated assembly over the terrain and populating a third subset of the solution property space in dependence upon the motion specification information;
(e) defining parameterised curves relating to modifiable properties within the solution property space to generate values for said modifiable properties;
(f) simulating the dynamic motion of the articulated assembly over the terrain in dependence upon the solution property space to establish a solved property space;
(g) generating an error value relating to the level of inconsistency between the determined values in the solved property space and the values of the solution property space;
(h) determining whether the error value meets a predetermined threshold; wherein
upon determining the error value meets the predetermined threshold establishing the solved property space as the result; and
upon determining the error value does not meet the predetermined threshold varying a subset of the modifiable properties in dependence upon the parameterised curves and repeating steps (e) to (h) with the solution property space adjusted for the varied subset of the modifiable properties.

2. The method according to claim 1, wherein
those elements in the first to third subsets of the solution property space not defined within their respective specifications are populated with default values.

3. The method according to claim 1, further comprising
(i) controlling the articulated assembly in dependence upon the solved solution space.

4. The method according to claim 1, further comprising
establishing a physical law specification defining variations in physical laws applicable to the motion of the articulated assembly over the terrain and amending a fourth subset of the solution property space in dependence upon the physical law specification information wherein those elements in the fourth subset of the solution property space not defined within the physical law specification are populated with default values.

5. The method according to claim 1, wherein
at least one of
steps (b) to (h) are initially performed with the specifications populating the solution property space defined at a coarse granularity and the solved property space is used to constrain the search for the subset of the modifiable properties in dependence upon the parameterised curves; and
the solved property space from a single time instant is projected forward as the solution property space for a next time instant.

6. The method according to claim 1, wherein
at least one of:
the search for the subset of the modifiable properties in dependence upon the parameterised curves is performed in dependence upon random perturbations; and
the search for the subset of the modifiable properties in dependence upon the parameterised curves is performed in dependence upon a gradient search.

7. The method according to claim 1, wherein
either
the motion specification defines a time interval for establishing the solved solution property space; or
a time interval between a previous solved solution space and the current solution space is established in dependence upon at least an aspect of the terrain specification relating to the current position of the articulated assembly, a current configuration of the articulated assembly and the actuation states of the articulated assembly.

8. The method according to claim 1, wherein
each parameterised curve encodes values of a property within the solution property space over a time period represented by the solution property space.

9. The method according to claim 1, wherein
the motion specification is established using at least one motion template of a plurality of motion templates.

10. The method according to claim 1, wherein
the terrain specification is established in dependence upon a current location of a user; and
the motion specification is established in dependence upon a current motion mode of a user or a selection of a motion mode made by the user.

11. A system comprising:
an articulated assembly providing motion of the articulated assembly over terrain;
a microprocessor coupled to a non-volatile, non-transitory memory for establishing a control sequence for controlling the articulated assembly; and
the non-volatile, non-transitory memory for storing data relating to the articulated assembly and computer executable instructions which when executed relate to a process establishing the control sequence, the process comprising the steps of:
(a) defining and initializing a solution property space within a memory of a computer system;
(b) establishing an assembly specification relating to an articulated assembly and populating a first subset of the solution property space in dependence upon the assembly specification information;
(c) establishing a terrain specification relating to a terrain over which the articulated assembly is to move and populating a second subset of the solution property space in dependence upon the terrain specification;
(d) establishing a motion specification defining the motion of the articulated assembly over the terrain and populating a third subset of the solution property space in dependence upon the motion specification information;
(e) defining parameterised curves relating to modifiable properties within the solution property space to generate values for said modifiable properties;
(f) simulating the dynamic motion of the articulated assembly over the terrain in dependence upon the solution property space to establish a solved property space;
(g) generating an error value relating to the level of inconsistency between the determined values in the solved property space and the values of the solution property space;
(h) determining whether the error value meets a predetermined threshold;
wherein
upon determining the error value meets the predetermined threshold using the established solved property space to control the articulated assembly; and
upon determining the error value does not meet the predetermined threshold varying a subset of the modifiable properties in dependence upon the parameterised curves and repeating steps (e) to (h) with the solution property space adjusted for the varied subset of the modifiable properties.

11. The system according to claim 11, wherein
those elements in the first to third subsets of the solution property space not defined within their respective specifications are populated with default values.

12. The system according to claim 11, further comprising
(i) controlling the articulated assembly in dependence upon the solved solution space.

13. The system according to claim 11, further comprising
establishing a physical law specification defining variations in physical laws applicable to the motion of the articulated assembly over the terrain and amending a fourth subset of the solution property space in dependence upon the physical law specification information wherein those elements in the fourth subset of the solution property space not defined within the physical law specification are populated with default values.

14. The system according to claim 11, wherein
at least one of
steps (b) to (h) are initially performed with the specifications populating the solution property space defined at a course granularity and the solved property space is used to constrain the search for the subset of the modifiable properties in dependence upon the parameterised curves; and
the solved property space from a single time instant is projected forward as the solution property space for a next time instant.

15. The system according to claim 11, wherein
at least one of:
the search for the subset of the modifiable properties in dependence upon the parameterised curves is performed in dependence upon random perturbations; and
the search for the subset of the modifiable properties in dependence upon the parameterised curves is performed in dependence upon a gradient search.

16. The system according to claim 11, wherein
either
the motion specification defines a time interval for establishing the solved solution property space; or
a time interval between a previous solved solution space and the current solution space is established in dependence upon at least an aspect of the terrain specification relating to the current position of the articulated assembly, a current configuration of the articulated assembly and the actuation states of the articulated assembly.

17. The system according to claim 11, wherein
each parameterised curve encodes values of a property within the solution property space over a time period represented by the solution property space.

18. The system according to claim 11, wherein
the motion specification is established using at least one motion template of a plurality of motion templates.

19. The system according to claim 11, wherein
the terrain specification is established in dependence upon a current location of a user; and
the motion specification is established in dependence upon a current motion mode of a user or a selection of a motion mode made by the user.

20. A non-volatile, non-transitory memory for storing computer executable instructions which when executed relate to a process comprising the steps of:
(a) defining and initializing a solution property space within a memory of a computer system;
(b) establishing an assembly specification relating to an articulated assembly and populating a first subset of the solution property space in dependence upon the assembly specification information;
(c) establishing a terrain specification relating to a terrain over which the articulated assembly is to move and populating a second subset of the solution property space in dependence upon the terrain specification;
(d) establishing a motion specification defining the motion of the articulated assembly over the terrain and populating a third subset of the solution property space in dependence upon the motion specification information;
(e) defining parameterised curves relating to modifiable properties within the solution property space to generate values for said modifiable properties;
(f) simulating the dynamic motion of the articulated assembly over the terrain in dependence upon the solution property space to establish a solved property space;
(g) generating an error value relating to the level of inconsistency between the determined values in the solved property space and the values of the solution property space;
(h) determining whether the error value meets a predetermined threshold; wherein
upon determining the error value meets the predetermined threshold establishing the solved property space as the result; and
upon determining the error value does not meet the predetermined threshold varying a subset of the modifiable properties in dependence upon the parameterised curves and repeating steps (e) to (h) with the solution property space adjusted for the varied subset of the modifiable properties.
